(19) United States
(12) Patent Application Publication
(10) Pub. No.: US 2026/0332989 A1
(43) Pub. Date: Oct. 22, 2026

(54) ANTI-THEFT SYSTEM

(71) Applicant: AUTOMOBILITY DISTRIBUTION INC., Montréal (CA)

(72) Inventor: Robert NELSON, Westmount (CA)

(21) Appl. No.: 19/553,258

(22) Filed: Feb. 28, 2026

Related U.S. Application Data
(60) Provisional application No. 63/765,254, filed on Feb. 28, 2025.

(51) Int. Cl. H04W 4/029; B60R 25/33; B60R 25/40; H04W 4/80

(52) U.S. Cl. CPC H04W 4/029; B60R 25/33; B60R 25/403; H04W 4/80

(57) ABSTRACT

Systems and methods are provided for anti-theft devices. In some embodiments, a master anti-theft device is provided to detect potential tamper signals, optionally accompanied with a number of satellite devices or additional master anti-theft devices to monitor the primary master anti-theft device. If potential tamper signals are detected, and an authentication device is not detected nearby, the devices may activate long range communication and positioning apparatuses to contact a user and inform them of a potential theft. The devices may turn off in accordance with user commands. The devices may operate in low-power modes when long range communication and positioning functionality is not needed.

The present application claims priority from U.S. provisional patent application No. 63/765,254 filed on Feb. 28, 2025, incorporated herein by reference.

### TECHNICAL FIELD

The present patent application relates to the field of tracking devices, for example as may be applied to automobile security.

### BACKGROUND

Vehicle tracking systems are widely used. When a vehicle is stolen, a thief can attempt to remove or disable the vehicle tracking device in the vehicle. Many tracking devices use cellular network wireless communications and/or GPS receivers that consume high enough levels of power such that the devices require a wired connection to vehicle power to have a good service life.

### SUMMARY

The applicant has found that vehicle tracking devices wired to vehicle power are often found by thieves and disabled. Applicant proposes embodiments including those that include tracking devices only powered by battery for a long service life that can be hidden in a vehicle, while still using power hungry components such as cellular transceivers and GPS receivers. It will be understood that the application of the tracking devices proposed herein need not be limited to vehicles, but to any mobile property that is susceptible to theft.

The applicant has discovered a new system that may address the issue of vehicle theft. In a preferred embodiment, the system may be composed of a master device and one or more satellite devices. The master device may operate in a low power mode and may detect vehicle movement, such as through an accelerometer. When detecting movement, the master device may send out a short-range signal to locate an authentication device, such as a user phone. If an authentication device is located within a certain range, the master device may disable itself for a certain amount of time. If an authentication device is not nearby, the master device may enter an active mode and send an alert to the user over a long range communication. The user may then indicate whether the alert is a false-alarm or a theft. If the user indicates it is a theft, the master device may activate its positioning unit and send regular long range communications to the user, showing its location and allowing a user to locate the stolen vehicle.

In a preferred embodiment, there may be an anti-theft system, comprising: a master anti-theft device, comprising: a power source; and a short range transceiver; and at least one satellite device, each comprising: a satellite battery; a satellite short range transceiver; a satellite long range transceiver; and a satellite positioning unit; wherein said master anti-theft device is configured to stop or change a transmission of signals using said short range transceiver when disconnected or tampered or when detecting a potential tamper signal of a tracked object; wherein said at least one satellite device is configured to operate in a satellite low-power mode, wherein: at least said satellite long range transceiver and said satellite positioning unit are not powered; and said satellite short range transceiver is configured to monitor said transmission of signals from said short-range transceiver to detect whether said master anti-theft device remains nearby and/or operational; and wherein said at least one satellite device is configured to enter a satellite active mode when said master anti-theft device is detected to not be nearby and/or operational or when said transmission of signals changes, wherein: said satellite positioning unit and said satellite long range transceiver are powered; and wherein said satellite positioning unit is configured to determine a satellite location and said satellite long range transceiver is configured to transmit said satellite location.

In some embodiments, the master anti-theft device further comprises: a processor; and a memory, storing instructions that when executed by the processor allow the processor to operate said short range transceiver and ignore disconnection or tampering of said master anti-theft device or said potential tamper signal; and the at least one satellite device further comprises: a processor; and a memory, storing instructions that when executed by the processor allow the processor to operate the satellite long range transceiver and the satellite positioning unit and return the satellite device to said satellite low-power mode.

In some embodiments, upon receiving a turn off command from a user, said at least one satellite device is configured to return to said low power mode and to send a short range turn off communication to said master device causing said master device to ignore disconnection or tampering of said master anti-theft device or said potential tamper signal for a predetermined amount of time.

In some embodiments, the master anti-theft device further comprising an interruption apparatus and wherein said short range transceiver is configured to periodically connect to an authentication device, to cause said interruption apparatus to interrupt a critical system of said tracked object when said connection is unsuccessful and to cause said interruption apparatus to cease interrupting said critical system of said tracked object when said connection is successful.

In some embodiments, said potential tamper signal is an attempt to use said critical system while said critical system is interrupted by said interruption apparatus.

In some embodiments, said master anti-theft device is powered by an external power supply and said at least one satellite device is battery-powered.

In another preferred embodiment, there may be a master anti-theft device for a tracked object, comprising: a battery; a sensing apparatus; a short range transceiver; a long range transceiver; and a positioning unit; wherein said master anti-theft device is configured to operate in a low-power mode, wherein: at least said long range transceiver and said positioning unit are not powered; said short range transceiver is configured to periodically attempt to connect to an authentication device; and said sensing apparatus is configured to detect a potential tamper signal; wherein said master anti-theft device is configured to enter an active mode when said potential tamper signal is detected while connection to an authentication device is unsuccessful or when said master anti-theft device is disconnected or tampered, wherein: said positioning unit and said long range transceiver become powered; and said positioning unit is configured to determine a location of a tracked object and said long range transceiver is configured to transmit said location to a user.

In some embodiments, the device may further comprise: a processor; and a memory, storing instructions that when executed by the processor allow the processor to operate the long range transceiver and the positioning unit and return the master anti-theft device to said low-power mode.

In some embodiments, the system may further comprise: at least one satellite device, each comprising: a satellite battery; a satellite short range transceiver; a satellite long range transceiver; and a satellite positioning unit; wherein said master anti-theft device is configured to stop or change a transmission of signals using said short range transceiver when disconnected or tampered or when detecting said potential tamper signal; wherein said at least one satellite device is configured to operate in a satellite low-power mode, wherein: at least said satellite long range transceiver and said satellite positioning unit are not powered; and said satellite short range transceiver is configured to monitor said transmission of signals from said short-range transceiver to detect said master device remains nearby and/or operational; and wherein said at least one satellite device is configured to enter a satellite active mode when said master anti-theft device is detected to not be nearby and/or operational or when said transmission of signals changes, wherein: said satellite positioning unit and said satellite long range transceiver are powered; and wherein said satellite positioning unit is configured to determine a satellite location and said satellite long range transceiver is configured to transmit said satellite location.

In some embodiments, the at least one satellite device may further comprise: a satellite processor; and a satellite memory, storing instructions that when executed by the processor allow the processor to operate the satellite long range transceiver and the satellite positioning unit and return the satellite device to said satellite low-power mode.

In some embodiments, said master anti-theft device further comprises a power input and is powered by an external power supply via said power input and said at least one satellite device is battery-powered.

In some embodiments, said master device and said at least one satellite device are configured to return to said low power mode and said satellite low power mode, respectively, for a predetermined amount of time upon receiving a turn off command from a user.

In some embodiments, the device may further comprise: a plurality of n additional master anti-theft devices; wherein each of said plurality of n additional master anti-theft devices is configured to stop or change a transmission of signals using said short range transceiver when disconnected or tampered or when detecting said potential tamper signal; wherein each of said plurality of n master devices is configured to operate in a dormant low-power mode by default, wherein: at least said long range transceiver and said positioning unit are not powered; and said short range transceiver of an nth master anti-theft device is configured to monitor said transmission of signals from a short-range transceiver of an n−1th master anti-theft device; wherein each of said plurality of n master devices is configured to enter a current master mode when said transmission of signals of said n−1th master anti-theft device changes, in which each of said plurality of n master devices is configured to: enter by default said low-power mode; and enter said active mode when said potential tamper signal is detected while connection to an authentication device is unsuccessful or when said master anti-theft device is disconnected or tampered; wherein the n−1th master anti-theft device of a first of said plurality of n additional master anti-theft devices is said master anti-theft device.

In a preferred embodiment, there may be a method of detecting theft and reporting location of a tracked object, said method comprising: detecting a potential tamper signal; periodically attempting to connect to a nearby authentication device using a short range transceiver; when detecting said potential tamper signal and when said connection is unsuccessful, transmitting an alert to a user device using a long range transceiver; receiving a user response to said alert or waiting for a minimum predetermined amount of time to pass in the absence of said user response, said user response either confirming potential theft and a need for tracking or a false alarm and a lack of need for tracking; in the case of need for tracking or the absence of said user response, repeating, at regular intervals: determining a location using a positioning unit; and transmitting said location to said remote server or user device; and in the case of lack of need for tracking, suspending steps a) to d) for a predetermined amount of time.

In some embodiments, the method may further comprise when connection to said authentication device is unsuccessful, disabling the functionality of a critical system of said tracked object.

In some embodiments, the method may further comprise receiving a user command to turn off, and returning to a low power mode for a predetermined amount of time by depowering said positioning unit and said long range transceiver.

In some embodiments, said repeating, at regular intervals further comprises attempting to connect to said authentication device using said short range transceiver and returning to a low power mode for a predetermined amount of time by depowering said positioning unit and said long range transceiver if said connection is successful.

In some embodiments, the method may further comprise, prior to detecting said potential tamper signal, operating in a dormant mode, comprising, at regular intervals, attempting to locate a nearby device using said short range transceiver and only beginning said detecting a tamper signal when said nearby device is not located.

In some embodiments, the method may further comprise changing a transmission of signals using said short range transceiver when disconnected or tampered or when said tracked object is tampered.

In some embodiments, said tracked object is a vehicle and said potential tamper signal is acceleration above a predetermined threshold detected by an accelerometer.

### BRIEF DESCRIPTION OF THE DRAWINGS

The invention will be better understood by way of the following detailed description of embodiments of the invention with reference to the appended drawings, in which:

FIG. 1A is a schematic diagram of an exemplary master device.

FIG. 1B is a schematic diagram of an exemplary master device.

FIG. 1C is a schematic diagram of an exemplary immobilizing master device.

FIG. 1D is a schematic diagram of an exemplary master device.

FIG. 2A is a schematic diagram of an exemplary satellite device.

FIG. 2B is a schematic diagram of an exemplary satellite device.

FIG. 2C is a schematic diagram of an exemplary satellite device.

FIGS. 3A, 3B and 3C are schematic diagrams of three exemplary embodiments of the system.

FIGS. 4A and 4B are schematic diagrams of two exemplary embodiments of the system.

FIG. 5A is a flow chart diagram of an exemplary embodiment of device behaviour.

FIG. 5B is a flow chart diagram of an exemplary embodiment of device behaviour.

FIG. 5C is a flow chart diagram of an exemplary embodiment of device behaviour.

FIG. 5D is a flow chart diagram of an exemplary embodiment of device behaviour.

FIG. 6 is a diagram illustrating the process involved in a normal communications session between the tracking device, the authentication device and the server.

FIG. 7 is a flow chart diagram of a method of installing an anti-theft system in a tracked object.

### DETAILED DESCRIPTION

Throughout the specification, reference is made to vehicles, as a prime example of an object that may be tracked by the current system. It should be understood that the system and methods described herein may be used to track all manner of objects, not limited to vehicles, such as parcels, groups of parcels, animals, etc.

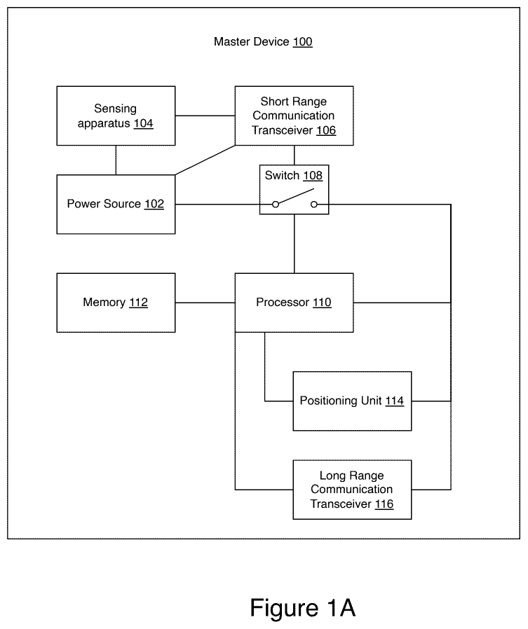

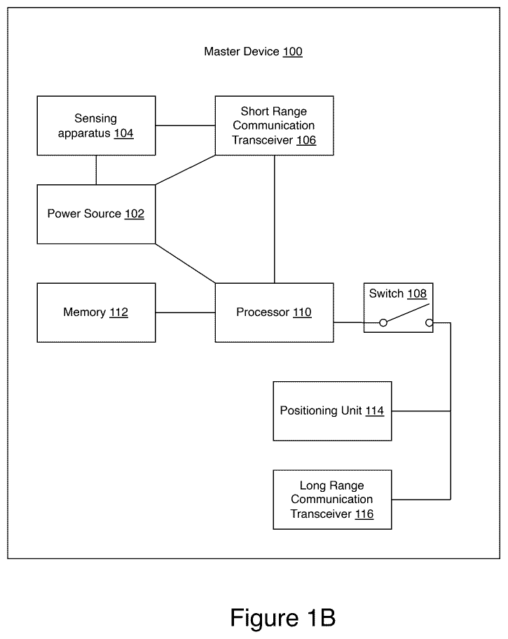

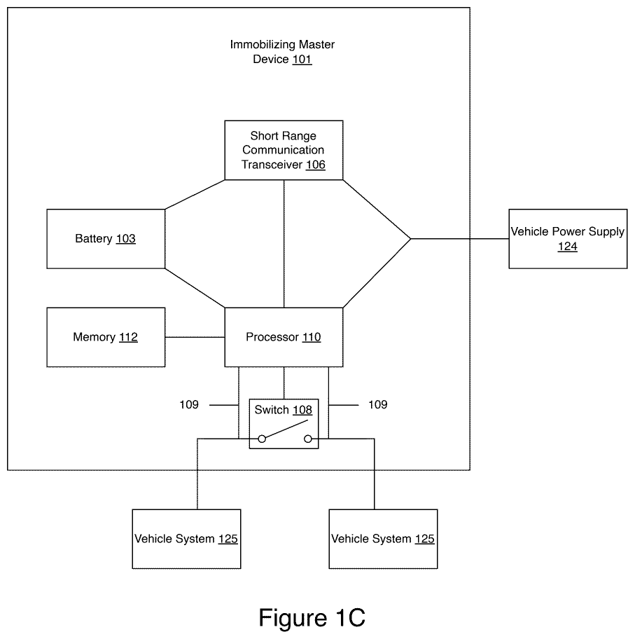

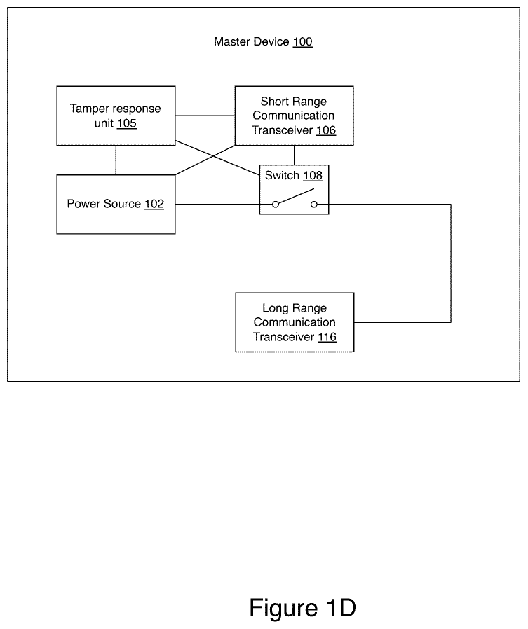

FIG. 1A is a schematic diagram of an exemplary master device. A master device 100 may include a power source 102 that may be connected to, for supplying power to, a sensing apparatus 104 (which may also be referred to as a tamper sensor) and a short range communication transceiver 106. The sensing apparatus 104 may be connected to the short range communication transceiver, which may cause the short range communication transceiver to act when a potential tamper signal is detected. For example, the sensing apparatus 104 may be an accelerometer, and the potential tamper signal may be acceleration above a predetermined threshold. The power source 102 may also be connected to, for supplying power to, a processor 110, a positioning unit 114 and a long range communication transceiver 116, however, these connections may be controlled by a switch 108. The processor may be further connected to a memory 112, storing instructions to be executed by the processor, and connected to, for controlling, the positioning unit 114 and long range communication transceiver 116. The switch 108 may be controlled by the short range communication transceiver 106 and by the processor 110.

FIG. 1B is a schematic diagram of an exemplary master device. The main difference from the FIG. 1A embodiment is that power is supplied to the processor 110 by default. This may allow for the processor to execute some low-power background functions (e.g., a timer) and allow a master device to have basic decision-making capabilities even in a sleep mode. A master device 100 may include a power source 102 that may be connected to, for supplying power to, a sensing apparatus 104, a short range communication transceiver 106 and a processor 110. The sensing apparatus 104 may be connected to the short range communication transceiver, which may cause the short range communication transceiver to act when a potential tamper signal is detected. The power source 102 may also be connected to, for supplying power to, a positioning unit 114 and a long range communication transceiver 116, however, these connections may be controlled by a switch 108. The processor may be further connected to a memory 112, storing instructions to be executed by the processor, and connected to, for controlling, the positioning unit 114 and long range communication transceiver 116. The switch 108 may be controlled by the short range communication transceiver 106 and by the processor 110 or, as represented, only by the processor 110.

In some embodiments, the power source 102 may be a battery, or a connection to a vehicle power supply, such as a vehicle battery. The power source of the master device may be referred to alternatively as a power input, as power is being inputted into the master device (by battery, connection to the vehicle, or otherwise).

In some embodiments, the short range transceiver 106 may be connected to the processor 110, for informing the processor e.g., of functioning or communications of the short range transceiver, for example, the result of an attempt to locate an authentication device.

In some embodiments, it may not be necessary for the master device 100 to have a positioning unit 114 and a long range communication transceiver 116, if the master device 100 is accompanied with other devices that have such capabilities, e.g., a satellite device described below.

The master device may operate in a low power mode. In such a mode, the power source 102 may power the sensing apparatus 104 and the short range communication transceiver 106 (and, in 1B, the processor 110) and the switch 108 may be off (not allowing current) (and therefore, power supply to the positioning unit 114 and long range communication transceiver 116 (and, in 1A, the processor 110) may be disabled). As the sensing apparatus 104 and short range communication transceiver 106 may consume a very small amount of energy (especially when compared to the positioning unit 114 and long range communication transceiver 116), the master device 100 may operate a very long time on limited power. This is especially useful when the power source 102 is a battery.

The master device may operate in an active mode where the switch 108 may be on (allowing current) and therefore powering positioning unit 114 and long range communication transceiver 116 (and, in 1A, the processor 110). The master device 100 may consume a much greater amount of energy when these components are active, but these components allow for greater functionality, namely remote communication with the user. When in an active mode, the master device may act like a tracking device.

In an ideal embodiment, the master device may operate in a sleep mode by default. In such a sleep mode, the only elements that are powered may be the sensing apparatus (e.g., accelerometer, for detecting acceleration), and the short range communication transceiver, for occasionally communicating with other master or satellite devices, such as by emitting a heartbeat signal to indicate normal operation, and in the embodiment of FIG. 1B, the processor for low-power functions. The signal emitted by the master device's short range transceiver to indicate normal operation may be referred to as the dormant signal and includes e.g., a heartbeat signal. In other cases, tampering may cause the master device to emit a positive signal of tampering (which may be referred to as a tamper signal), causing other devices (e.g., satellite devices) to become active. When the accelerometer detects acceleration above a predetermined threshold, the accelerometer may send a signal to the short range transceiver to cause the short range transceiver to send a short range wireless communication signal to locate a nearby user authentication device. If a user authentication device is detected nearby, the acceleration is likely due to the user driving the vehicle, and the master device may remain in a low power mode. If a user authentication device is not nearby, the vehicle movement may be due to an unauthorized user driving the vehicle. The short range communication transceiver may therefore turn the switch on, granting power to positioning unit and long range communication transceiver, and in the embodiment of FIG. 1A, to the processor. The short range communication transceiver may also sent a short range distress signal to nearby master or satellite devices. The processor may then communicate with a remote user via the long range communication transceiver. If the user indicates there is no theft (e.g., they lent their vehicle to a person who does not have an authentication device), the processor may terminate communication and cause the switch to close, making the master device re-enter sleep mode. If the user indicates that there is theft, the processor may obtain positioning data from the positioning unit and transmit it to the user via the long range communication transceiver. The processor may continue to update the user with the device position until the user indicates the vehicle has been found. Upon a user command, the alerts may cease and the master device may re-enter sleep mode.

The master device may be configured to have a dormant mode, where it does not respond to the detection of a potential tamper signal, but merely measures nearby device(s) using a short range transceiver.

It should be understood that many elements and connections within the master device, such as the sensing apparatus' signal to the short range communication transceiver, may be electromechanical so as to maximally reduce power consumption. In some embodiments, the short range transceiver may be a Bluetooth™ low energy (BLE) transceiver. In some embodiments, the memory and processor may be agglomerated together as a microcontroller.

In some embodiments, the authentication device may be a user phone or other electronic device with short range communication capabilities. In some embodiments, the system may require that the authentication device be paired with the master device (and other devices) prior to use. In some embodiments, the master device may communicate with a user indirectly through a remote server.

In some embodiments, if the user does not respond to alerts within a given time limit, the master device may begin sending the user alerts and position data. In some embodiments, the system may be configured to send alerts and/or position data to one or more third parties, such as trusted individuals or local law enforcement, especially in cases where the primary user does not respond to alerts.

In some embodiments, short range communications from a user device may cause the master device to enter an active mode. This may be useful, for example, in pairing user authentication devices with the master device or modifying device settings in the memory or processor.

In some embodiment, the memory may be configured to store all locations that have been determined by the positioning unit, such that if the long range transceiver is unsuccessful at communicating the position, they may be recorded for later investigation.

In some embodiments, said long range transceiver may be a cell chip for connecting to cellular networks. In some embodiments, said positioning unit may be a GPS unit.

In some embodiments, logic for controlling said long range transceiver and said positioning unit may be built into the device electromechanically, and therefore the device may not require a processor and memory.

FIG. 1C is a schematic diagram of an exemplary immobilizing master device. In this embodiment, the immobilizing master device may not need power-hungry long range communication or a positioning unit. The immobilizing master device 101 may include a power source, which may be a battery 103 or a vehicle power supply 124 (in some embodiments, the immobilizing master device 101 may only have one of these power supplies). The immobilizing master device 101 may have a short range communication transceiver 106 for receiving and sending short range communications such as Bluetooth signals, a processor 110 and a memory 112 for storing instructions and/or programs to be executed by the processor 110, and a switch 108 that is interfacing with a vehicle system 125. The immobilizing master device may be considered or referred to as a type of master device.

In some embodiments, the immobilizing master device may further include a long range communication transceiver and/or a positioning unit. However, these may be unnecessary in a system containing other devices with these capabilities/components.

In a preferred embodiment, the vehicle system 125 may be critical to the functioning of a vehicle. For example, the vehicle system 125 may be a wire through which an ignition signal passes to the engine. Therefore, the immobilizing master device 101 may have control over a critical system through the switch 108.

The immobilizing master device may operate in a low-power mode in which only the short range communication transceiver and processor are powered. The short range communication transceiver may periodically attempt to locate a nearby authentication device, for example by periodically emitting short range communications and detecting responses (or the absence of responses). If an authentication device is detected nearby, the processor may be configured to turn on the switch to allow signals to pass through a vehicle system in a normal fashion (e.g., an ignition signal that allows a vehicle engine to start running). If the authentication device is not detected nearby, the processor may be configured to turn off the switch, thereby interrupting signals through a vehicle system (e.g., preventing ignition signals from reaching the engine). Therefore, without a nearby authentication device of a user, the vehicle may not be able to operate, preventing theft.

In some embodiments, if the device receives a signal to turn off, the processor may cause the switch to become on for a predetermined amount of time, allowing the vehicle to be operated according to a user's approval.

In a preferred embodiment, the processor 110 may be configured to detect, for example via wires 109, signals passing through vehicle system 125. This may allow the device to detect attempts to operate the vehicle when no authentication device is nearby, and alert the device to a potential theft, or detect if the master immobilizing device 101 has been removed from the vehicle system 125.

In some embodiments, the processor 110 may be configured to detect when it is receiving power from a battery 103 or from a vehicle power supply 124. In this way, the immobilizing master device 101 may detect if it has been removed from the vehicle (e.g., by a thief that has disconnected the immobilizing master device 101 from the vehicle power supply 124).

In a preferred embodiment, the immobilizing master device may be accompanied by one or more satellite devices (described further below). If the immobilizing master device detects attempts to operate the vehicle without a nearby authentication device, or detects that its connection to the vehicle system or vehicle power supply has been compromised, the immobilizing master device may be configured to send out a short range distress signal that may be received by one or more nearby satellite devices. In response to such distress signals, the satellite devices may enter an active mode in which they send long range communication alerts to a user with positioning information.

In some embodiments, in order to monitor a nearby device, master devices or satellite devices may be configured to send out regular short range communications to each other using their short range transceivers. Upon detecting anomalous activity (e.g., detecting a potential tamper signal when no authentication device is nearby) a device may change the transmissions or communications that are regularly being sent. This change in transmissions may be measured or detected by other devices, alerting them to the possibility of theft and possibly causing them to enter an active mode. In this description, this change in transmissions may sometimes be referred to as a distress signal.

The detection of nearby authentication devices may be done by specialized short range device authenticators separate from the short range transceivers, or integrated with the short range transceivers, such as Bluetooth chips programmed to recognize specific devices. Authentication signals may be emitted regularly, or regularly upon detecting a potential tamper signal, or regularly after a tamper has been detected and the devices are in an active mode. Detecting a response from an authenticated device may cause the tamper response to cease.

In some embodiments, a potential tamper signal is any measurable indication that a tamper may be occurring. For example, the acceleration above a certain threshold may be a potential tamper signal. It may be potential because, if an authentication device is nearby, there may not be cause for worry, as the user may be operating the vehicle or using the tracked object as normal. The detecting of an ignition signal, described below, may also be a potential tamper signal that is suspicious in the absence of an authentication device.

In some embodiments, the master device may be configured to detect whether it is being tampered or disconnected. For example, this may occur based on the master device no longer being physically or electrically connected to a vehicle or object (e.g., no longer receiving power from an external power source, no longer in circuit with vehicle electronic communication, etc.).

In a preferred embodiment, the satellite devices may also be configured to monitor the immobilizing master device, such that if the immobilizing master device is removed from the vehicle (e.g., by a thief), the satellite device may enter an active mode in which they send long range communication alerts to a user with positioning information.

In some embodiments, the satellite devices may not immediately send positioning data to the user. To conserve power, it may be beneficial that, in a first communication to the user, the satellite device may merely inform the user of a potential alert and let the user determine whether there is an alert or not. In some embodiments, there may be a timer or delay in which a user may answer. If there is no answer, or if the user indicates that there is a theft, the positioning unit of the satellite device may be turned on and the positioning data be sent to the user.

In some embodiments, the satellite device or the master device may be configured to receive a command from a user to turn off the system (e.g., due to a false alarm or after the recovery of the vehicle in a real alarm). The satellite device may send a short range communication to the immobilizing master device to return to a non-alert state, before the satellite device itself returns to a low power mode. The master device receiving the communication via its own long range transceiver may return to a non-active mode and deactivate any tamper response based on the user turn off command, re-emit the dormant signal and therefore cause the satellite devices to re-enter their sleep mode.

In some embodiments, the immobilizing master device's connection to the vehicle system may be accomplished in different ways, such as through connecting to a vehicle bus, acting as an interposer within a vehicle wire, connecting in between two vehicle system connections, etc. The immobilizing master device may include a connecting apparatus, such as a male and female connector pair.

FIG. 1D is a schematic diagram of an exemplary master device. Here, the master device 100 is shown in a simplified format. It may have a power source 102, connected to a tamper response unit 105, a short range communications transceiver 106 and a long range communication transceiver 116. A switch 108, controllable by the short range communication transceiver, may interface between the power source 102 and the long range communication transceiver 116.

A tamper response unit is any unit that can receive a potential tamper indicator and cause a tamper response. For example, the tamper response unit may be made only of a sensing apparatus as discussed above, sensing stimuli (e.g., acceleration) that may indicate a tamper, such that an electrical signal is outputted by the tamper response unit that will cause the tamper response. The tamper response unit may comprise multiple sensors, such as an accelerometer and an engine status detector, and be configured to cause the tamper response when certain combinations of stimuli, such as acceleration without the engine being activated. The tamper response unit may have one or more data inputs for receiving data from sensors that are part of the vehicle, or from the vehicle's electrical control unit. The tamper response unit may include a short range device authenticator, such as a Bluetooth™ transceiver for attempting to locate nearby authenticated devices (e.g., to prevent the tamper response when the rightful vehicle owner is nearby). The tamper response unit may communicate with a long range transceiver, e.g., to receive communications from a user indicating tamper or no tamper and cause a tamper response based on such communications. The tamper response unit may include memory and a processor for making simple or complex determinations about whether to cause a tamper response based on aggregate potential tamper stimuli, user communications, predetermined rules and tamper response history, among other things. The tamper response unit may be configured to control a vehicle system, as controlled by the processor in FIG. 1C.

The tamper response unit may be in communication (by its own components, or via the master short or long range transceiver) with a vehicle control unit, one or more satellite devices, a user device or backend server and use the received information for determining whether a tamper takes place. For example, in a car, the tamper response unit may be connected to the car's electrical control unit to receive information about engine starting or tire rotation, such a started engine or tire rotation may be potential tamper signals that, if no authenticated device is nearby, may constitute a tampering of the tracked car.

The embodiment of FIG. 1D shows that a processor and memory are not necessary for the operation of the master device 100. The various components of the master device 100 may operate based on mechanical interaction—that is, mechanical switches and electronic circuits of varying complexity can accomplish the basic tasks of detecting tampering, alerting a user, turning off a tamper response, etc. For example, a sensing apparatus in the tamper response unit may receive a stimulus indicative of tampering and send an electrical pulse to the connected short range communication transceiver, causing the short range communication transceiver to deactivate for a period of time and causing the satellite devices to become active due to the master dormant signal being turned off.

It should also be noted that the master device (or satellite described below) may not contain any sensing apparatus or tamper response unit. In such embodiments, the system of master/satellite devices may not be able to detect when tampering or theft occurs, however, a user (upon discovering that their vehicle is stolen) may still be able to contact the system through a long range communication which will cause the master unit to begin transmitting its position to the user. This would allow the user to locate the vehicle, without requiring any additional components to measure or evaluated potential tampering.

In some embodiments, such as the one described above, the long range transceiver of the master unit may be always on, or be turned on periodically based on a timer, or be turned on while the vehicle is turned on, so that messages may be received from the user or from a server.

In some embodiments, a positioning unit in the master device may not be necessary, as the master device may rely on the positioning units of the satellite devices which can be turned on by the master device sending a tamper or distress signal.

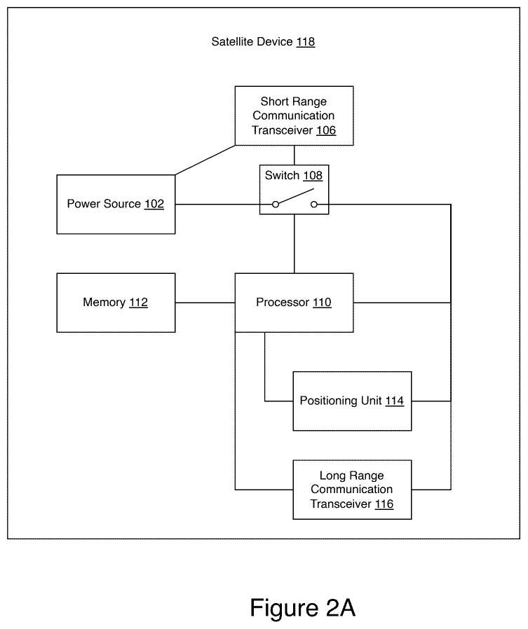

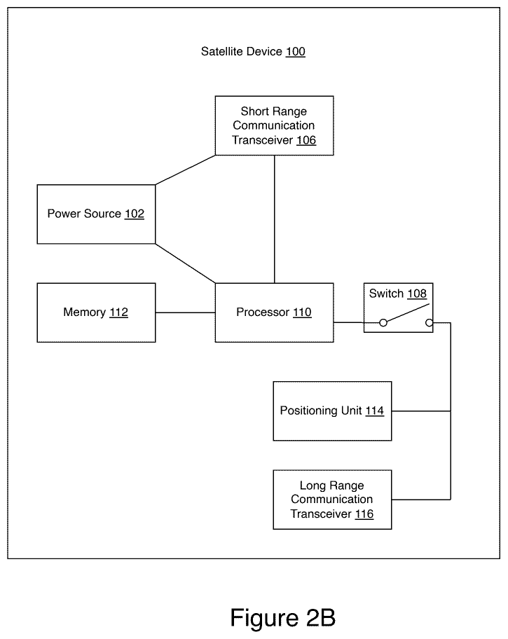

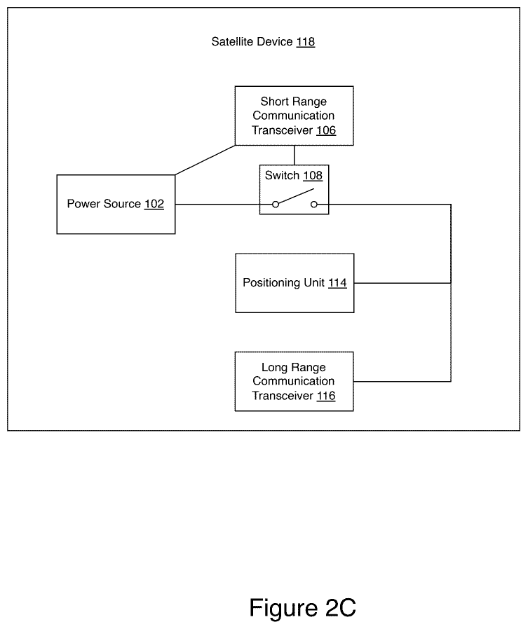

FIG. 2 is a schematic diagram of an exemplary satellite device. The satellite device 118 may include a power source 102 that may be connected to, for supplying power to a short range communication transceiver 106. The power source 102 may also be connected to, for supplying power to, a processor 110, a positioning unit 114 and a long range communication transceiver 116, however, these connections may be controlled by a switch 108. The processor may be further connected to a memory 112, storing instructions to be executed by the processor, and connected to, for controlling, the positioning unit 114 and long range communication transceiver 116. The switch 108 may be controlled by the short range communication transceiver 106 and by the processor 110.

FIG. 2B is a schematic diagram of an exemplary satellite device. The main difference from the FIG. 2A embodiment is that power is supplied to the processor 110 by default. This may allow for the processor to execute some low-power background functions (e.g., a timer) and allow a master device to have basic decision-making capabilities even in a sleep mode. The satellite device 118 may include a power source 102 that may be connected to, for supplying power to a short range communication transceiver 106 and the processor 110. The power source 102 may also be connected to, for supplying power to a positioning unit 114 and a long range communication transceiver 116, however, these connections may be controlled by a switch 108. The processor may be further connected to a memory 112, storing instructions to be executed by the processor, and connected to, for controlling, the positioning unit 114 and long range communication transceiver 116. The switch 108 may be controlled by the short range communication transceiver 106 and by the processor 110 or, as represented, only by the processor 110.

In some embodiments, the power source 102 may be a battery, or a connection to a vehicle power supply, such as a vehicle battery.

The satellite device may operate in a low power mode, where the power source may be supplying power only to the short range communication transceiver (and, in embodiments such as FIG. 2B, the processor). The satellited device may also operate in an active mode, where the switch is on, and the power source is supplying power to the positioning unit and long range communication transceiver (and, in embodiments such as FIG. 2A, the processor). When in an active mode, the satellite device may act like a tracking device.

In a preferred embodiment, the satellite device is a complementary device to the master device. The satellite device may be hidden somewhere in the vehicle, preferably away from the master device. The satellite device may act as a backup to the master device, in case the master device malfunctions or it removed from the vehicle. In some embodiments, there may be a plurality of satellite devices.

In a preferred embodiment, the satellite device may operate in a sleep mode by default, merely periodically verifying the presence of a nearby master device via the short range communication transceiver, such as through a heartbeat signal emitted by the master device. In some embodiments, it may also be configured to detect the presence of a distress signal from a nearby master device. When a master device is no longer detected nearby, or when a distress signal is detected from a master device, the satellite device may enter an active mode, turning the switch on and supplying power to the processor, positioning unit and long range communication transceiver. The satellite device may then periodically communicate its location to a user via the long range communication transceiver, until a user commands it to cease its activity, and it may then return to a low power mode.

In some embodiments, the satellite device may include its own sensing apparatus. In such cases, the sensing apparatus may be used to indicate when the satellite device should enter active mode or when it should verify the master device. For example, if the sensing apparatus is an accelerometer, the satellite device may only activate its short range transceiver when acceleration is detected.

FIG. 2C is a schematic diagram of an exemplary satellite device. In this embodiment, the satellite device 118 is simplified to show that it is possible to operate the satellite device 118 without the need of a processor or memory. Here, a power source 102 is connected to a short range communication transceiver 106, a positioning unit 114 and a long range communication transceiver 116. Power to the positioning unit 114 and the long range communication transceiver 116 is controlled by a switch 108, itself controlled by the short range communication transceiver 106. As was described with reference to the master device, all component parts of the satellite device 118 may operate without a processor or memory, based on mechanical connections and electronic circuits.

In some embodiments, the master device and/or satellite device may include one or more timers. These timers may serve as mechanical controllers for various components of the devices to improve the devices' functionality. For example, a timer may control a tamper response unit of a master device or a short range transceiver, long range transceiver or positioning unit of a satellite device, such as to disable functionality for a period of time. In a master device, this may be useful for disabling the system's tamper response for a duration after a user has indicated a false alarm. In a satellite device, this may be useful for extending a battery life of a satellite device by regularly disabling and re-enabling either short range transceiver functionality or longe range transceiver and positioning unit functionality, for example so that the system functions for a minute every two hours. Given the battery drain of long range transceivers and positioning units, this would greatly extend the life of satellite units. In some embodiments, the timer time may be variable, for example increasing based on repeated unsuccessful attempts at long range connection (e.g., the vehicle has been stored in an underground garage).

In some embodiments, satellite devices or master devices may be configured to activate their long range transceiver first, and only activating their positioning unit upon successfully establishing a long range connection with a user device or server. This may conserve battery.

In some embodiments, satellite devices may be configured to detect nearby satellite devices and determine their remaining battery life. This may be done by having a detector on the battery of each satellite device (this may be a simple threshold battery life detector), paired with a short range transceiver that transmits the remaining battery life in its signal. The satellite devices, either through a processor or mechanical determination, may determine which satellite device should become active in a tamper situation, for example to prioritize the usage of a device with larger remaining battery life, or vice versa, to completely consumer the battery of devices that are nearly depleted. In some cases, the satellite devices may simply respect an order of which one will become active a moment, if the devices preceding in the order are no longer detected.

In some embodiments, the master and satellite devices may be made of the same device with the same components. Such devices would have a power supply including a battery and a connection apparatus to be connected to a vehicle power supply, a short range transceiver, a long range transceiver, a tamper response unit and a positioning unit. That way, it may be produced and sold as a single unit. In such a case, one of the units may still be implemented as a master unit and connected to the power supply of the tracked vehicle, while the other units may be treated as satellite devices, operating in low-power mode to extend the life of their battery. They may be programmed to recognize each other.

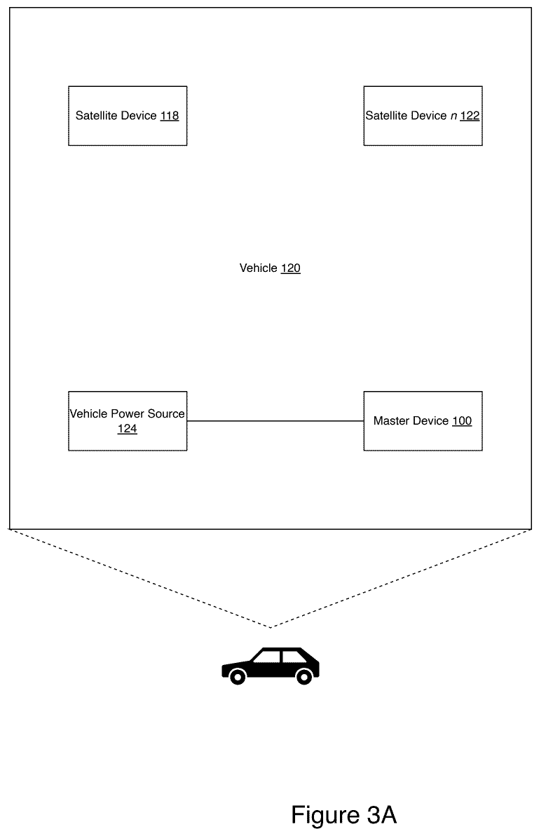

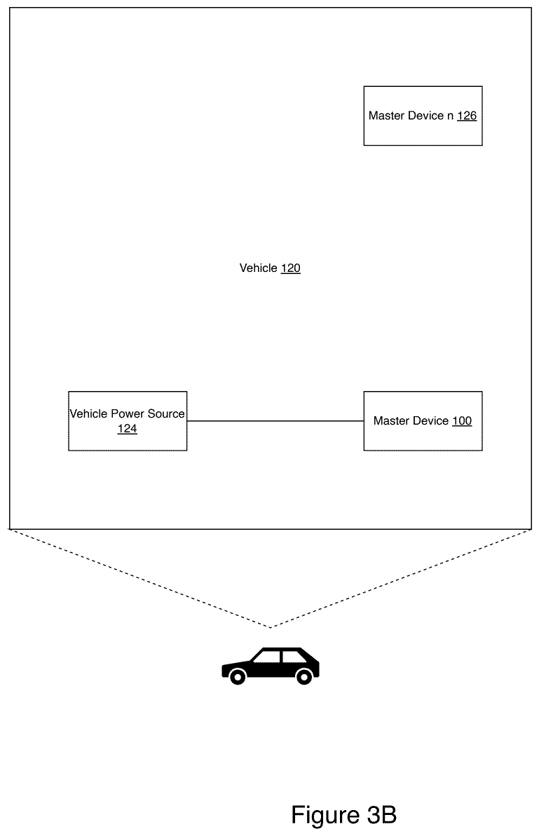

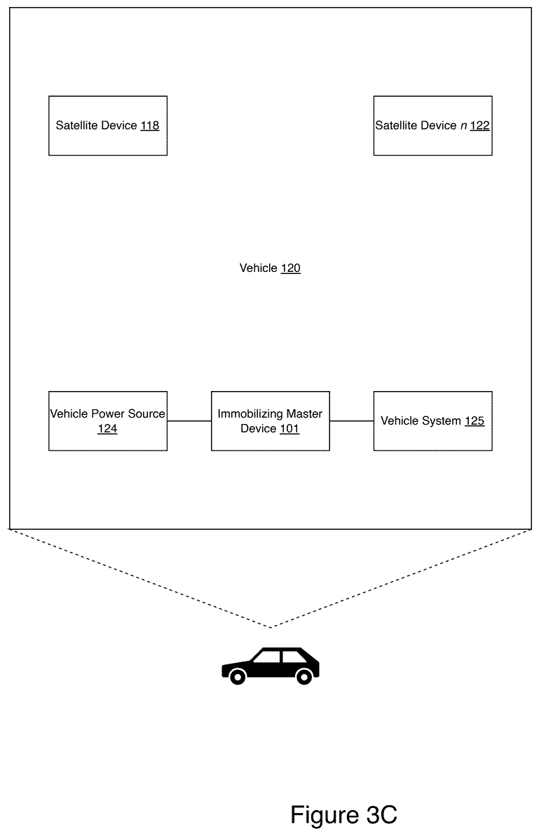

FIGS. 3A, 3B and 3C are schematic diagrams of three exemplary embodiments of the system. In FIG. 3A, there is a master device 100, a first satellite device 118 and a number n of optional additional satellite devices, where the nth satellite device is represented by satellite device n 122. These devices may be installed in a vehicle 120. The master device may be connected to a vehicle power source 124 and may be obviously placed, such as to attract the attention of a thief, so that the thief knows that vehicle 120 is protected by the system. The satellite devices may be hidden throughout the vehicle in hard-to-reach places, making it difficult for a thief to locate them all in a short period of time. Faced with the knowledge that the master device would alert a user to unauthorized vehicle movement, and that satellite devices would alert a user to a missing master device, a wise thief may simply decide to save their efforts for another victim.

In an exemplary embodiment, a master device 100 is connected to the vehicle power source 124 to allow the master device 100 to monitor the vehicle without concern for battery life. Multiple battery-powered satellite devices 118, 122 are scattered throughout the vehicle, their battery allowing them to be hidden in places without requiring additional wiring. The master device 100 would monitor vehicle operation and signal potential tampers to a user (including using a positioning unit and transmitting a location to a user). The satellite devices can be extremely simple—such as the one shown in FIG. 2C—operating in low-power mode with only their short range transceiver activated until they receive a tamper signal from the master device or stop receiving the dormant signal from the master device. Then, the first satellite device would enter an active mode, activating their positioning unit and long range transceiver, and begin transmitting a position to a user. Therefore, in practice, the satellite devices would be there only to ensure that the master device remains present and operational in the vehicle.

In some embodiments, the master device may be battery powered, and therefore not connected to a vehicle power source 124. However, due to the master device's functionality of locating nearby authentication devices and (especially) contacting the user over a long range when authentication devices are not nearby (even during false alarms, when the user commands the system to return to a low power mode), the master device may consume a greater amount of energy than the satellite devices. It is therefore preferred to have the master connected to the vehicle power source in an obvious way, and the satellite devices (which consume less energy) to be battery-powered and hidden throughout the vehicle. In some embodiments, some or all devices, including satellite devices, may be connected to a vehicle power source in some fashion, extending the lifetime of the system beyond the battery lifetime.

In some embodiments, multiple satellite devices may be ‘chained’ similar to master devices that operate by monitoring n−1th master devices (as described below). This may allow a system of multiple satellite devices to extend their battery life.

In some embodiments, both master or satellite devices may be configured to distribute the task of being in an active mode among each other. For example, each satellite device may become active only temporarily, and emit (or cease emitting) a signal to cause the next satellite device to become active. This may involve making a simple or complex determination of which device should become active. For example, the devices may have a predefined order between them and may activate only when previous devices in the order are no longer detected or are emitting a tamper signal. This may also involve each device emitting a signal about how much battery each one has remaining, and causing the one with the most or least battery to become active in preference over the others. Distributing the task of being in the active mode may be advantageous e.g., for distributing battery life among the various devices, and, by extension, ensuring that if one of the devices is found and removed by a thief, the other devices have sufficient battery remaining to be functional.

In FIG. 3B, the system may be comprised of a plurality of master devices, from a first master device 100 to an nth master device n 126. In this embodiment, the master devices may be scattered and hidden throughout the vehicle 120. In some embodiments, the first master device 100 may be connected to a vehicle power source 124. However, in a preferred embodiment, all master devices may be battery powered, so that they may be hidden throughout the vehicle.

Each master device may act independently, detecting potential tamper signals, locating nearby authentication devices, alerting users and sending location data as previously described. However, in some embodiments, it may be beneficial, especially for the purposes of extending the battery lifetime of the system, for the plurality of master devices to assign one master device to be the ‘current’ master device, whose functionality may include all that is described above, while the other master devices remain in a battery-saving sleep mode.

In this embodiment, each master device may be numbered or have an order, and each master device may be programmed to be in a dormant mode by default. Each master device may use short range communication to determine whether the master device that is sequentially before it in the numbering or ordering scheme is nearby (each nth master device monitors the n−1th master device). In such a case, each master device may be in a dormant mode, consuming minimal power, until the master device it is monitoring (the n−1th master device) is no longer nearby. When this occurs, the (nth) master device becomes the ‘current master device’ and remains in a low power mode, but becomes able to enter an active mode when a potential tamper signal (e.g., acceleration) is detected, and communicating with a user when an authentication device is not detected. It can also signal to nearby master devices to enter into active modes via a distress signal. In order to differentiate between a sleep mode where the master device may, in response to acceleration, check for a nearby authentication device, versus a sleep mode in which the master device merely monitors the n−1th master device, the former may be called a sleep mode and the latter may be called a dormant mode. In a dormant mode, a master device may not respond to different acceleration inputs. When in a current master mode, the master device may switch between low power modes and active modes. The dormant mode should consume the least amount of power of the three modes, with the sleep mode consuming less power than the active mode.

In some embodiments, it is also possible for there to merely be one master device, without additional master or satellite devices. Although the master device may be vulnerable to being removed, it may still greatly increase the security of the vehicle by providing location data to a user upon unauthorized vehicle movement.

In FIG. 3C, the system may be comprised of an immobilizing master device 101 and one or more satellite devices 118 to 122. The immobilizing master device 101 may be connected to a vehicle power source 124 and a vehicle system 125. If the immobilizing master device 101 is disconnected from either the vehicle power source 124 or the vehicle system 125, or if the immobilizing master device 101 detects the vehicle system being operated when an authentication device is not nearby, the immobilizing master device 101 may emit a distress signal to nearby satellite devices 118 to 122, causing them to communicate remotely with a user. The satellite devices 118 to 122 may also enter remote communication with a user if the immobilizing master device 101 is not detected nearby, signalling that it has been removed or is no longer operational.

In an embodiment such as FIG. 3C, the satellite devices may be ‘chained’ as with the master devices of FIG. 3B. A plurality of n satellite devices may have a numbering or ordering scheme so that each one has a unique number n and each one may be configured to monitor the (immobilizing) master device and/or the n−1th satellite device. This may allow for only one satellite device to become active for initial communications with the user or remote server and/or for sending location data, thereby extending the lifespan of the overall system as only one satellite device may be in an active mode at a given time.

In some embodiments, the first communication that a user may receive may be a query to the user, asking the user to verify whether the unusual behaviour of the vehicle is expected by the user (e.g., if the user lent the vehicle to a person that does not have an authentication device). The user may then indicate whether the unusual behaviour is expected by the user (not a theft), accompanied by a command to turn off the system for a certain amount of time (the time that the user expects the unusual but expected behaviour to last) so that the system does not constantly wake up and alert the user, or indicate that the behaviour is unexpected (a theft).

In some embodiments, the first communication may be different based on the circumstances. For example, if an immobilizing master device experiences disconnection from the vehicle system or the vehicle power source, events that would not occur during unusual but expected behaviour (e.g., it would not occur if the user lends their vehicle to another person), the system may not query the user about whether the unusual behaviour is expected or not. Devices may immediately enter active modes and the location may immediately be sent to a user with an alert of theft. Non limiting situations which may merit immediate action include: the disconnection of a master device (immobilizing or not) from a vehicle power source or vehicle system and the inability of a satellite device to locate the master device.

In some embodiments, a master device in active mode may attempt to locate nearby satellite devices or master devices. If the master device is unable to locate these nearby devices, it is likely because the master device has been removed from the vehicle. In this situation, immediately entering an active mode may be warranted.

In some embodiments, the user device or remote server may receive multiple communications of different urgencies. For example, in a system of multiple master devices, if one master device is disconnected by a thief, it will detect that it is no longer near any other master devices and immediately send a high urgency alert to the user or server indicating theft, while the other master devices of the system (still in the vehicle) may only send a low urgency communication to the user or server, asking whether the unusual behaviour is expected. In such a situation, the user device or server may prioritize the most urgent communications and, such as in the example above, automatically determine a theft has occurred based on the most urgent communication.

In some embodiments, the long range communication to the server may include various pieces of information to help a user make a determination about whether to turn the system off or instruct the system to enter an active mode. Such information may include the initial reason for the communication (e.g., which part of the system detected the irregularity), which vehicle the devices are associated with, a history of prior events, a last known location of the vehicle (or even a current location, if specified by the user in user settings that location information should be included in the initial communication, and therefore the positioning unit should be powered and a location determined prior to sending the long range communication), the urgency of the communication, etc.

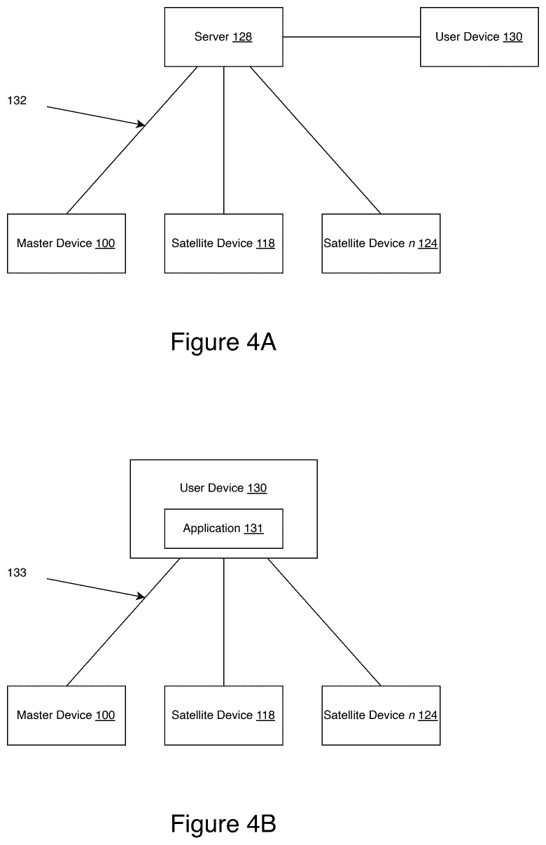

FIGS. 4A and 4B are schematic diagrams of two exemplary embodiments of the system. FIG. 4A shows the system in the embodiment where the master device(s) 100 and satellite device(s) 118 and 124 connect to a remote server 128 when engaging in long range communication 132. The server 128 may then relay the communication to a user device 130.

FIG. 4B shows the system in the embodiment where the master device(s) 100 and satellite device(s) 118 and 124 connect to the user device 130 directly when engaging in long range communication 133. The user device 130 may be configured to have an application 131 for interpreting communication signals, exchanging encrypted messages with the master and satellite devices, pairing authentication devices, etc.

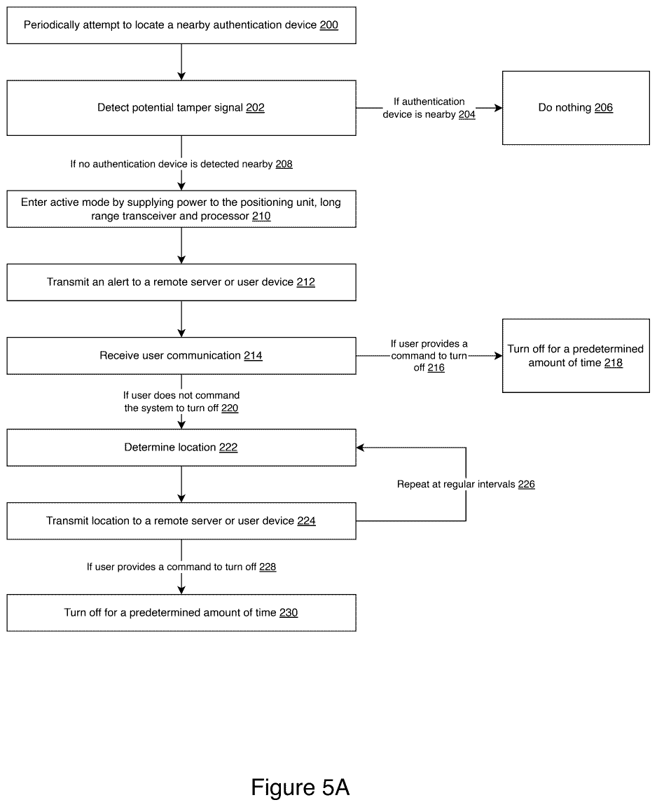

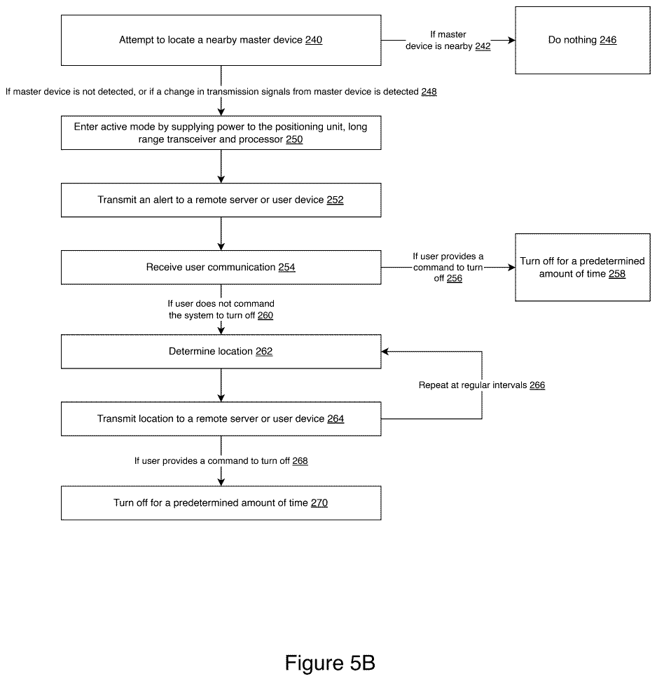

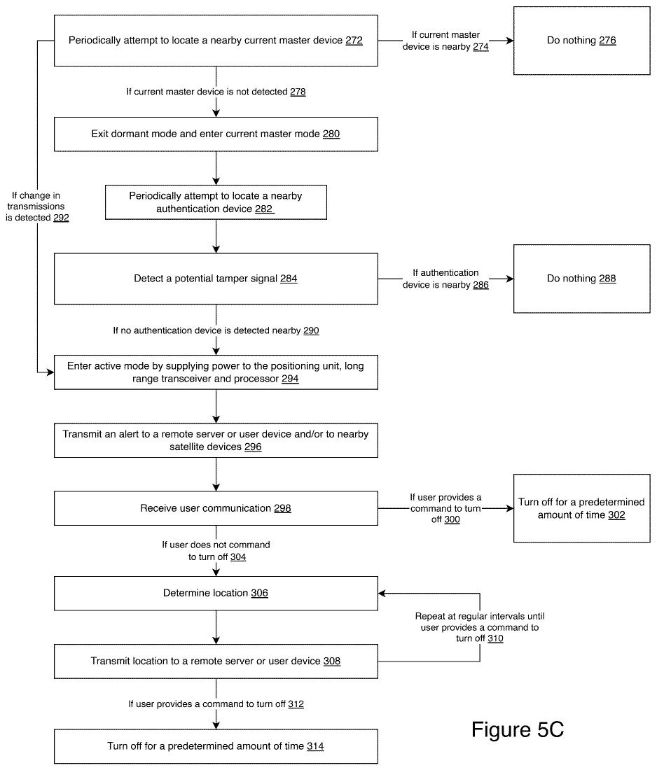

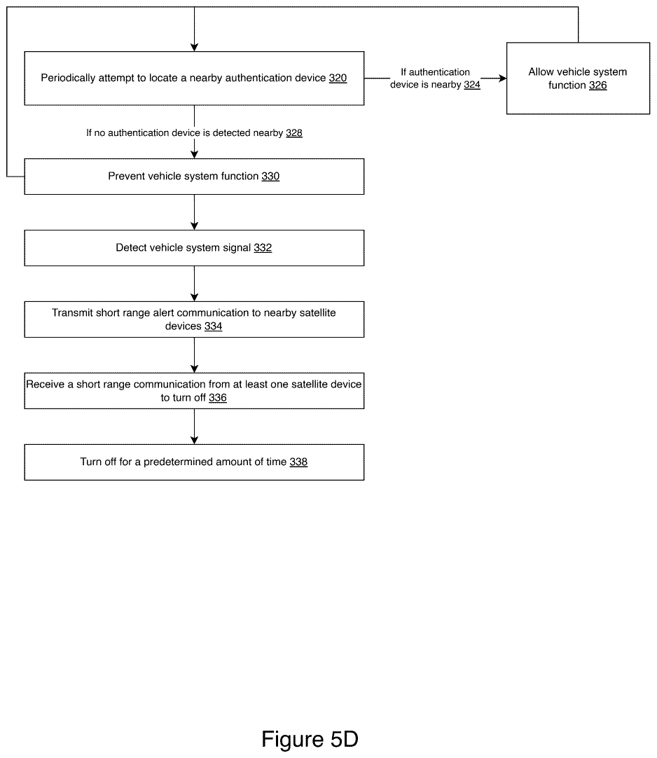

FIG. 5A is a flow chart diagram of an exemplary embodiment of device behaviour. In a preferred embodiment, this may be the behaviour of a master device. The device may begin by periodically attempting to locate a nearby authentication device 200. The device may then detect a potential tamper signal 202, such as a change in acceleration above a certain threshold or an attempt to ignite the engine of a vehicle. If the authentication device is nearby 204, which usually indicates that the object is safe (e.g., the user is driving the vehicle), the device may do nothing 206. If no authentication device is detected nearby 208, which usually indicates that an unauthorized use of the object (e.g., unauthorized driver). The device may therefore enter an active mode by supplying power to a positioning unit, long range transceiver and processor 210. The device may then transmit an alert to a remote server or user device 212. At this step, the device may optionally transmit a short range distress signal to nearby master or satellite devices, which may cause them to enter active modes and begin transmitting their location to a user. The device may then receive a user communication 214. If the user provides a command to turn off 216, such as when the user approves of who is driving the vehicle, the device may turn off for a predetermined amount of time 218. If the user does not command the system to turn off 220, the device may determine its location 222, for example with the help of a positioning unit, and may transmit its location to a remote server or user device 224, for example by a long range communication transceiver. The device may repeat these location determining and transmitting steps at regular intervals 226 to continually update a user about the location of the vehicle. If or when a user provides a command to turn off 228, the device may then turn off for a predetermined about of time 230.

Turning off for a predetermined amount of time may be important for saving power. For example, if a user without an authorized device is driving the vehicle (e.g., a neighbour who borrowed the car, who doesn't carry the phone of the main owner), it would be undesirable to constantly alert the user as the neighbour is driving. The user may specify a certain amount of time to turn off for (e.g., 2 hours, the duration of the neighbour's route) or the system may have a predetermined default time (e.g., 30 mins).

In some embodiments, a user may not answer an alert. For example, if the theft occurs at night, while a user is asleep, the user may not be able to transmit a communication in response to an alert. The system may therefore be configured to begin transmitting location data if an answer is not received by a user after a predetermined amount of time. In such a circumstance, the system may alert trusted third parties, such as trusted individuals or local law enforcement, and skip step 214 to begin transmitting its location to the user and trusted third parties. In some embodiments, the system may have a timer (e.g., 30 mins) before which it will cease waiting for a user communication.

In some embodiments, the system may turn itself off automatically upon detecting a nearby authentication device (e.g., a user finding their vehicle). Therefore, in some embodiments, the system may be configured to continually attempt to locate a nearby authentication device, even when in an alert mode.

The duration of the interval of step 228 may vary and may be tuned to user requirements. For example, if battery power is a concern, the intervals may be lengthened to only update location every half hour. If battery power is not a concern, the location may be updated almost continuously, such as every second. In some embodiments, the user may manually tune the interval, for example, using a larger interval when the user is far away, but as user (and/or law enforcement) gets closer to the vehicle, the user may instruct the interval to be reduced, for better pinpointing of the vehicle location.

In some embodiments, detecting acceleration (or any tamper signal) above a threshold may require defining a threshold in user settings. A balance may need to be made between a low threshold (which will be sensitive to false alarms) and a high threshold (which may not be activate if driving is smooth).

FIG. 5B is a flow chart diagram of an exemplary embodiment of device behaviour. In a preferred embodiment, this may exemplify the behaviour of a satellite device. The device may attempt to locate a nearby master device 240. This may occur repeatedly, at regular intervals. If a master device is nearby 242, the device may do nothing 244. If a master device is not detected, or if a change in transmission signals from a master device is detected 248, this may indicate that a vehicle is being stolen, and the device may enter an active mode by supplying power to a positioning unit, long range transceiver and processor 250. The device may then transmit an alert to a remote server or user device 252. The device may then receive user communication 254. If the user provides a command to turn off 256, the device may turn off for a predetermined amount of time 258. If the user does not command the system to turn off 260, the device may determine its location 262 and transmit the location to a remote server or user device 264. The determining and transmission of location may repeat at regular intervals 266 until a user provides a command to turn off 268, at which point the device may turn off for a predetermined amount of time 270.

In some embodiments, attempting to locate a nearby master device may involve a number of different behaviours. In some embodiments, the master device (or each master device) may periodically emit a heartbeat signal that is expected to be received by the satellite device or other master device. Upon not receiving the heartbeat, the satellite device or other master device may determine that the master device is not nearby or is defective. In some embodiments, the satellite device or other master device may periodically send a signal to the master device to elicit a response communication from the master device, confirming its continued presence and operation.

FIG. 5C is a flow chart diagram of an exemplary embodiment of device behaviour. In a preferred embodiment, this may exemplify the behaviour of a master device in a system of master devices. The device may attempt to locate a nearby current master device 272. If a current master device is nearby 274, the device may do nothing 276. If a current master device is not detected 278, the device may exit a dormant mode and enter a current master mode 280, and begin periodically attempting to locate a nearby authentication device 282. The device may then detect a potential tamper signal 284. If the authentication device is nearby 286, the device may do nothing 288. If no authentication device is detected nearby 290, the device may enter an active mode by supplying power to a positioning unit, long range transceiver and processor 294. The device may alternatively enter into the active mode following a change in transmissions 292 sent by another master device. The device may then transmit an alert to a remote server or user device 296, and optionally may transmit an alert or distress signal to nearby master or satellite devices. The device may then receive a user communication 298. If a user provides a command to turn off 300, the device may turn off for a predetermined amount of time 302. If a user dos not provide a command to turn off 304, the device may determine a location 306 and then transmit the location to a remove server or user device 308. The device may repeat the steps of determining and transmitting a location at regular intervals until a user provides a command to turn off 310, and if a user provides a command to turn off 312, the device may turn off for a predetermined amount of time 314.

In some embodiments, a set of master devices may have a numbering from 1 to n master devices. Each master device may monitor one or a plurality of other master devices in a sleep mode. In some embodiments, each master device of number x may only monitor the master device that is numbered x−1. When the x−1th device becomes non-operational, the x^{th} master device may become the ‘current master’ device. In some embodiments, all master devices except the current master device may operate in a sleep power mode where they only monitor the x−1th master device (and does not act based on sensing apparatus (e.g., accelerometer) input), while the current master device may operate in a sleep mode that, upon receiving input from a sensing apparatus detecting a potential tamper signal, can attempt to locate an authentication device and, upon not detecting such a device, enter an active mode for remote communication with a user.

FIG. 5D is a flow chart diagram of an exemplary embodiment of device behaviour. In a preferred embodiment, this may exemplify the behaviour of an immobilizing master device. The device may periodically attempt to locate a nearby authentication device 320. If the authentication device is nearby 324, the device may allow normal vehicle system function 326. However, if no authentication device is detected nearby 328, the device may prevent vehicle system function 330, such as by turning off a switch that allows signals to pass through the vehicle system. The device may, while the vehicle system function is preventing, detect a vehicle system signal 332, attempting to operate the vehicle system. The device may then transmit short range alert communications to nearby satellite devices 334. After a certain amount of time, or if the user indicates to cease the alert, the device may receive a short range communication from at least one satellite device to turn off 336, or in some embodiments where the immobilizing master device has a long range communication transceiver, may receive this communication directly from the user. The device may then turn off for a predetermined amount of time 338, or for an amount of time determined by the user communication.

In some embodiments, an element of the system (server, user device, user application or a master or satellite device) may be configured to analyze the location data sent to the user for consistency. If more than one location is being transmitted to the user (e.g., if a thief locates one or more master or satellite devices and removes some of them from the vehicle, the removed devices and the devices remaining in the vehicle may concurrently transmit location data), an element of the system may be configured to determine which signal is representative, or likely to be representative, of the vehicle. This may be determined, for example, by analyzing accelerometer data, comparing location data to a saved last known location (e.g., devices at a saved last known location may represent devices removed from the vehicle), or comparing location data between a plurality of devices (e.g., if 4 satellite devices are transmitting one location but a (presumably removed) master device is transmitting a different one, the hidden satellite devices are likely still in the vehicle and transmitting the correct vehicle location).

In some embodiments, a master device may be configured to enter an active mode and transmit location data if no input (e.g., acceleration) is received for a long period of time (e.g., if the device is disconnected and lost).

In some embodiments, a special adhesive or adhesive device covering may be used to attach the master or satellite devices to different parts of a vehicle. In some embodiments, such a special adhesive or adhesive device covering may be configured to bind almost irreversibly to metal and plastic components, with the option to remove them by applying a slow-acting solvent (which would only act after, e.g., 1 hour). This would allow users to remove or replace devices in the safety of their home or a garage, but not allow thieves to easily remove the devices.

In some embodiments, the master and/or satellite devices may include further components, such as a noise-generation component (allowing the device to be located by a human at a short range), other sensors (e.g., a camera or microphone for recording theft events), a replaceable battery port (allowing batteries to be replaced and the lifetime of the device extended), etc.

In some embodiments, a system may be used with a combination of any number of master (including immobilizing) and satellite devices.

The term “sensing apparatus” means any apparatus capable of detecting an unusual state of a vehicle or object or a potential tamper signal by sensing a change in the vehicle or object or the environment of the vehicle or object. Preferred examples of sensing apparatuses in the description above include the accelerometer and wires for connecting and measuring a vehicle system.

The term “interruption apparatus” means any apparatus capable of interrupting the normal functioning of a vehicle or object, making said vehicle or object unusable unless the interrupting device is removed or an authentication device is nearby to cause the interruption apparatus to cease interrupting the normal functioning of said vehicle or object. A preferred example of interruption apparatus in the description above includes the switch in FIG. 1C, interrupting the vehicle system, which may be a critical system such as an ignition signal, electrical power supply from a battery, or a release of brakes.

In some embodiments, the term “anti-theft” may include any device capable of performing some kind of verification as to whether an object is being stolen. This may include various kinds of forms of authentication, such as authenticating a user device, authenticating a user (e.g., through fingerprint), etc. This may also include verifying a state of an object, such as ensuring that the object is within a particular area (geofencing).

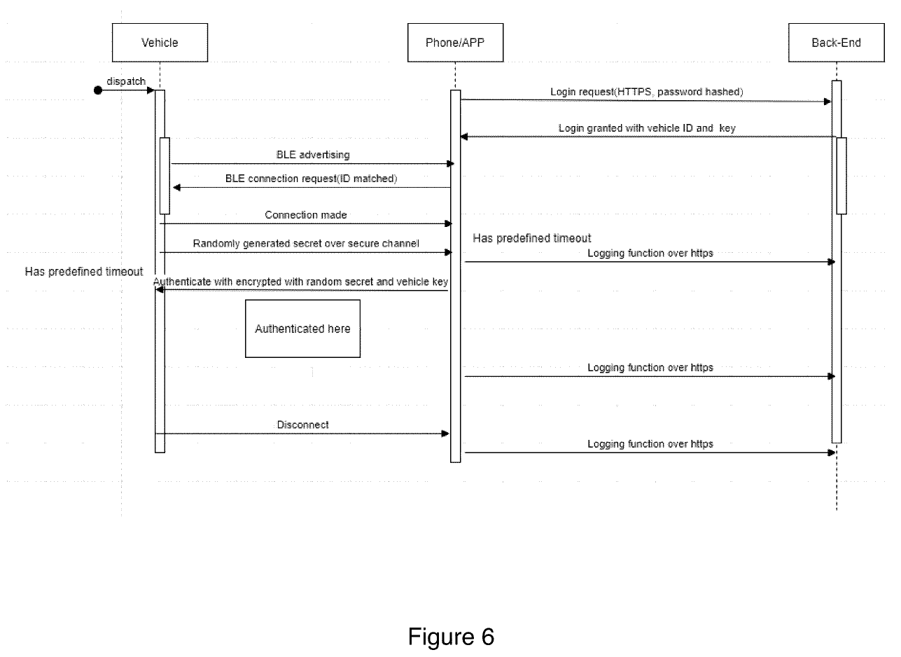

FIG. 6 is a diagram illustrating the process involved in a normal communications session between the tracking device, the authentication device and the server. The authentication device can be an app running on a smartphone as an example. It may run in a background mode. In the example of FIG. 6, the authentication device initially establishes a connection with the server, for example a back-end server, and obtains credentials for the tracking device, for example a cryptographic key. This may be done by the phone sending a login request, for example over an HTTPS connection with a hashed password with the server providing a vehicle ID and key in response.

The tracking device may use a Bluetooth® low energy (BLE) transceiver that advertises. The phone being paired with the tracking device responds to the advertising and establishes a secure connection. Authentication of the phone can be done by using the key received from the server to encrypt a randomly generated secret received from the tracking device. In this way, the tracking device can authenticate the user.

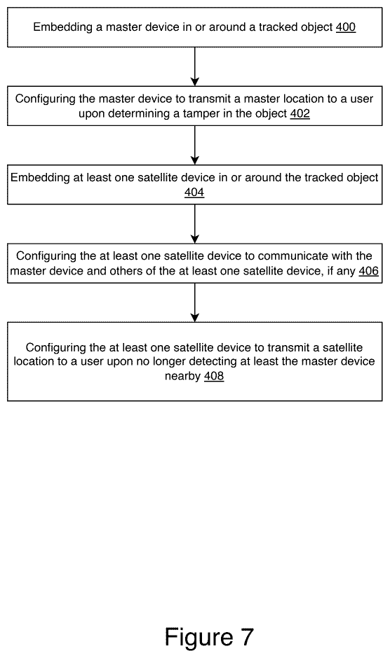

FIG. 7 is a flow chart diagram showing a method of installing an anti-theft system in a tracked object. The method may begin by embedding a master device in or around a tracked object 400. This may include connecting the master device to a vehicle power supply. This may also include securing the master device to a part of the vehicle, such as gluing, screwing, taping, soldering, or otherwise immobilising the master device to a frame, engine, electrical control unit or other part.

The method may include configuring the master device to transmit a master location to a user upon determining a tamper in the object 402. This may include providing the master device with instructions for how to contact a user (e.g., providing a phone number, IP address, or merely instructions for the master device to reach out to a pre-programmed server). This may also include pairing the master device with one or more devices that are meant to be authenticated devices, such that the master's short range transceiver or short range device authenticator can detect or authenticate the authenticated devices upon detecting a potential tamper. This may also include providing one or more tamper sensors or configuring the master device to respond in a certain way to one or more potential tampers (e.g., setting a threshold acceleration for tamper detection, or if a master unit is connected to the vehicle's electrical control unit, using tire rotation as a potential tamper indicator). This may also include configuring the master device to respond in a certain way upon detecting a tamper, such as an ordered list of which user to alert first, how long to keep the tamper response going, how long to deactivate upon receiving a deactivation communication, or which satellite devices should become active and in what order. This may include any one or more of the above-mentioned items.

The method may include embedding at least one satellite device in or around the object 404. In an ideal embodiment, the satellite devices may be hidden around the object, however, it is not strictly necessary for them to be hidden. Embedding may include such as gluing, screwing, taping, soldering, or otherwise immobilising the satellite device(s) to a frame, engine, electrical control unit or other part. In an ideal embodiment, they are embedded in separate locations, making them harder to find and remove by a potential thief, but this is not strictly necessary.

The method may include configuring the at least one satellite device to communicate with the master device and others of the at least one satellite device, if any 406. This may include pairing the satellite device(s) with each other and/or with the master device so that they can recognize each other's signals via their respective short range transceivers. This may include programming the satellite devices with an order to follow for activation, or with rules to follow for activation (e.g., activating based on battery threshold).

The method may include configuring the at least one satellite device to transmit a satellite location to a user upon no longer detecting at least the master device nearby 408. This may include providing the satellite device(s) with instructions for how to contact a user (e.g., providing a phone number, IP address, or merely instructions for the satellite device(s) to reach out to a pre-programmed server). This may include programming the satellite devices with an order to follow for activation, or with rules to follow for activation (e.g., activating based on battery threshold). This may include programming the satellite devices with an order to follow for activation, or with rules to follow for activation (e.g., activating based on battery threshold), if not done at a previous step. This may include rules for how to act when a in an active mode, such as for how long to remain active for, whether to turn off periodically to extend battery life, etc.

In various embodiments, the steps of the method of FIG. 7 may not need to be done in order. For example, satellite devices may be configured and embedded first. The configuring of the satellite or master devices may occur before embedding.

Alternatives, modifications and options described in relation to one embodiment may also apply to other embodiments. For example, variations in reference to the master device may apply to the satellite device and vice versa.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

What is claimed is:

1. An anti-theft system for securing an object, comprising:
a master device, comprising:
a master power input;
a master long range transceiver; and
a master short range transceiver configured to emit a dormant signal;
a satellite device, comprising:
a satellite power source;
a satellite positioning unit that, when powered, determines a satellite geographical location;
a satellite long range transceiver, connected to the satellite positioning unit, that, when powered, transmits the satellite geographical location;
an active mode switch controlling power supply to the satellite positioning unit and the satellite long range transceiver; and
a satellite short range transceiver configured to turn on the active mode switch when no longer detecting the dormant signal.

2. The system of claim 1, wherein the master power input is connectable to a power supply of the object and said satellite power source is a battery.

3. The system of claim 1, the master device further comprising a master positioning unit for determining a master geographical location and the master long range transceiver is connected to the master positioning to transmit the master geographical location.

4. The system of claim 1, the master device further comprising a short range device authenticator.

5. The system of claim 1, wherein the satellite short range transceiver is further configured to turn off the active mode switch upon detecting the dormant signal.

6. The system of claim 1, the master anti-theft device further comprising a tamper response unit comprising a tamper sensor.

7. The system of claim 6, wherein the tamper sensor is an accelerometer.

8. The system of claim 6, wherein the tamper response unit is connected to a control unit or sensor of the object and is configured to receive a potential tamper indicator by the control unit or sensor.

9. The system of claim 6, wherein the tamper response unit is connected to a critical system of the object is configured to interrupt normal functioning of the critical system of the object upon detecting a tamper.

10. The system of claim 6, the master anti-theft device further comprising:
a tamper switch connecting the tamper response unit to the master power input; and
a timer controlling the tamper switch configured to turn the tamper switch off for a period of time after the master device receives a deactivation communication.

11. The system of claim 1, the master anti-theft device further comprising:
a master processor connected to the components of the master device; and
a master memory storing instructions that when executed by the master processor cause the master processor to analyze the information received by components of the master device to determine what actions to take, if any, in a tamper response.

12. The system of claim 1, wherein a tamper response is configured to end upon receiving a deactivation communication from an authenticated device.

13. The system of claim 1, the satellite device further comprising a timer interfacing between the satellite short range transceiver and the active mode switch and wherein the timer is configured to deactivate and reactivate the active mode switch at timed intervals while the dormant signal is no longer detected by the satellite short range transceiver.

14. The system of claim 1, further comprising additional satellite devices and each satellite short range transceiver configured to emit a satellite signal.

15. The system of claim 14, wherein each one of the satellite devices have a position in an order, and the satellite signal encodes the position, and the satellite short range transceiver is configured to activate the active mode switch when no longer detecting the dormant signal or the signal of satellite devices preceding in the order.

16. The system of claim 14, wherein the satellite devices and the master device are identical devices.

17. The system of claim 14, wherein each one of the satellite devices is capable of transmitting a short range request to other satellite devices to cause one of the other satellite device to turn on its active mode switch.

18. A method of outfitting an object with an anti-tracking system, said method comprising:
embedding a master device in or around an object and connecting the master device to a power supply of the object;
configuring the master device to transmit a master location to a user upon determining a tamper in the object;
embedding at least one satellite device in or around the object;
configuring the at least one satellite device to communicate with the master device and others of the at least one satellite device, if any; and
configuring the at least one satellite device to transmit a satellite location to a user upon no longer detecting at least the master device nearby.

19. An anti-theft device, comprising:
a power source;
a positioning unit that, when powered, determines a geographical location;
a long range transceiver connected to the positioning unit, that, when powered, transmits the geographical location;
an active mode switch controlling power supply to the positioning unit and the long range transceiver;
a short range transceiver; and
a memory programmable to store a list of related devices in communication with the anti-theft device by the short range transceiver;
wherein the short range transceiver is configured to turn on the active mode switch at least based on related signals emitted by the related devices; and
wherein the short range transceiver is configured to, in response to the active mode switch turning off, emit or cease emitting a signal to cause at least one of the related devices to enter into an active mode.

20. The anti-theft device of claim 19:
wherein the power source is a battery; and
the anti-theft device further comprises a battery threshold detector configured to turn the active mode switch off when the battery reaches a threshold of remaining power.
